(19) United States
(12) Patent Application Publication
(10) Pub. No.: US 2008/0062712 A1
(43) Pub. Date: Mar. 13, 2008

(54) Sparsely Spaced Array Led Headlamp

(76) Inventor: Ronald O. Woodward, Yorktown, VA (US)

Correspondence Address: MAGNA INTERNATIONAL, INC., 337 MAGNA DRIVE, AURORA, ON, L4G-7K1, CA

(21) Appl. No.: 11/575,704

(22) PCT Filed: Sep. 21, 2005
(86) PCT No.: PCT/US05/33777

§ 371 Date: Jul. 13, 2007

Related U.S. Application Data
(60) Provisional application No. 60/611,764, filed on Sep. 21, 2004.

(51) Int. Cl. F21S 8/10; G02B 6/04

(52) U.S. Cl. 362/554; 362/520

(57) ABSTRACT

A headlamp comprising at least one array of illumination light sources, the light sources positioned substantially corresponding to a desired illumination beam pattern for the headlight, the light from the light source of the array being provided to a lens which projects the light in the illumination beam pattern. Preferably, the light is provided from LED light sources which are coupled to fiber optic cables to form the array of illumination source. Also preferably, the light sources can be illuminated in different patterns, to provide different illumination beam patterns.

### FIELD OF THE INVENTION

The present invention relates to automotive headlamps. More specifically, the present invention relates to LED-based headlamps.

### BACKGROUND OF THE INVENTION

With recent advance is semiconductor technology, the output power of white LEDs has increased to the point where automotive headlamps employing such LEDs as light sources are being developed. However, even with these recent advances, individual LEDs emit much less light than the incandescent or gas discharge light sources they are replacing and thus multiple LED devices must be employed within the headlamp to obtain the necessary illumination levels. At the same time, for cost and other reasons, it is desired to employ as few LED light sources as necessary to meet illumination levels in the headlamp.

Conventional headlamp system optics employ reflectors, masks and/or lenses to direct and focus the light emitted by very few, typically one or two, light sources and these optics can waste emitted light as the light emitted by such sources is abundant. As LED-based headlamps will have many light sources and as the emitted illumination must be carefully managed, as the level of the emitted illumination is low compared to incandescent or gas discharge sources, conventional headlamp system optics are not appropriate for LED-based headlamps. Further, an additional factor to be considered is that the operating temperature LED light sources must be carefully managed as the LED light sources generate a significant amount of heat while operating and must be cooled to preserve their operating lifetimes.

Accordingly, conventional headlamp system optics and designs are not appropriate to LED headlamps.

### SUMMARY OF THE INVENTION

It is an object of the present invention to provide a novel LED headlamp which obviates or mitigates at least one disadvantage of the prior art.

According to one aspect of the present invention, there is provided a headlamp projecting at least one illumination beam pattern, comprising: a first array of illumination light sources, the light sources arranged within the first array in a pattern which substantially corresponds to the pattern of illumination which is desired to be produced by the headlamp; and a first converging lens having a substantially uniform spread, the uniform spread being larger in the horizontal direction than the vertical, the first lens receiving light produced by the first array of illumination sources and projecting the received light to form the at least one illumination beam pattern.

Preferably, the first array of illumination light sources comprises a plurality of fiber optic cables, one end of each respective fiber optic cable being optically coupled to a respective one of a plurality of LED light sources, the other end of each respective fiber optic cable being substantially arranged corresponding to the illumination beam pattern, whereby the light emitted by the LED light sources is transferred by the fiber optic cables to the first lens in substantially the illumination beam pattern. Also preferably, different ones of the light sources in the light source array can be illuminated to form different illumination beam patterns and these patterns can include high beam, low beam, fog lamp and day time running light patterns.

According to another aspect of the present invention, there is provided a headlamp employing a plurality of LED light sources as illumination sources, each respective LED light source being optically coupled to one end of a respective fiber optic cable, the other end of each fiber optic cable being arranged in an array having the general shape of a desired pattern of illumination to be output from the headlamp, the headlamp further including a lens to receive the light emitted from the ends of the fiber optic cables and to project that light into the desired illumination beam pattern.

### BRIEF DESCRIPTION OF THE DRAWINGS

Preferred embodiments of the present invention will now be described, by way of example only, with reference to the attached Figures, wherein:

FIG. 1 shows a schematic representation of the principle components of a headlamp in accordance with the present invention;

FIG. 2 shows the components of an illumination beam pattern former used in the headlamp of FIG. 1;

FIG. 3 shows an arrangement of light sources for the illumination beam pattern former of FIG. 2;

FIG. 4 shows the components of another illumination beam pattern former used in the headlamp of FIG. 1; and

FIG. 5 shows an arrangement of light sources for the illumination beam pattern former of FIG. 4.

### DETAILED DESCRIPTION OF THE INVENTION

In prior at approaches to designing LED-based headlamps, designers have tried to employ LED sources in manners which emulated a point source, such as an incandescent bulb or gas discharge bulb. The present inventor has determined that advantages can be obtained when constructing LED-based headlamps by arranging the LED light sources such that they are employed as a relatively sparse arrangement which generally corresponds to the desired beam pattern to be formed by the headlamp.

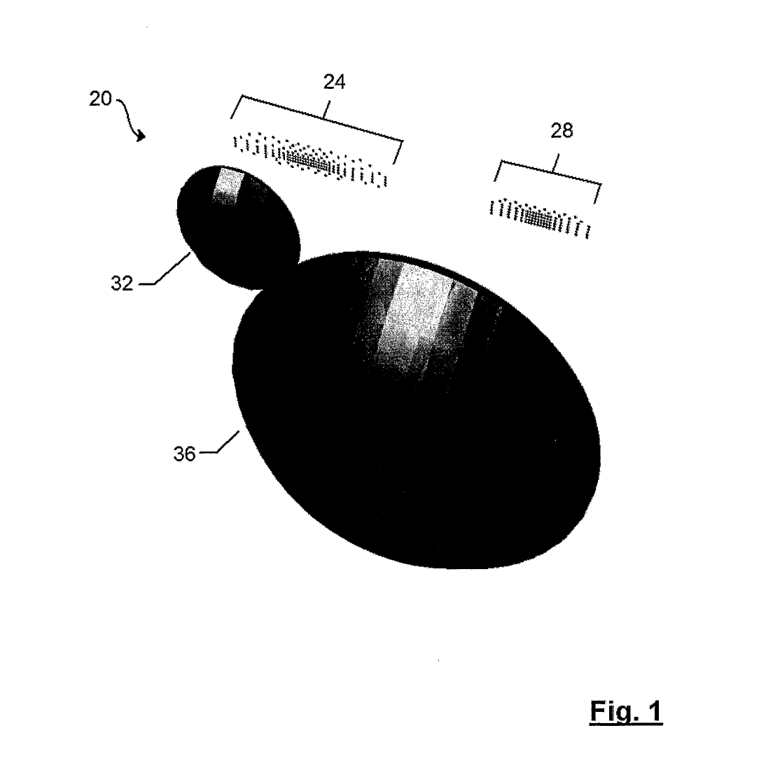

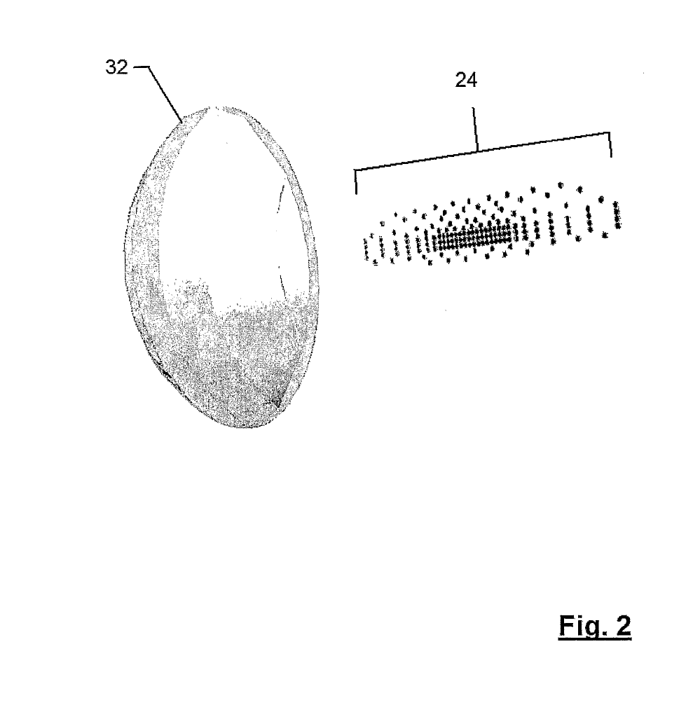

A headlamp in accordance with the present invention is indicated generally at 20 in FIG. 1. As illustrated, headlamp 20 includes two light source arrays 24 and 28 and two lenses 32 and 36. Each light source array 24, 28 is paired with a respective lens 32, 36 to obtain an illumination beam pattern former and the illumination beam pattern former comprising light source array 24 and lens 32 is shown in more detail in FIG. 2. This illumination beam pattern former is referred to herein as the spread illumination beam pattern former and light source array 28 and lens 36 are employed to obtain a second illumination beam pattern former, referred to here as the hot spot illumination beam pattern former and each of these pattern formers is described in more detail below.

Desired headlamp illumination beam patterns can be considered to comprise a spread pattern with one or more localized high intensity “hot spots” wherein the illumination levels are higher than other parts of the beam pattern. The present inventor has designed headlamp 20 with a spread illumination beam pattern former and a hot spot illumination beam pattern former, each of which provide their namesake components to the complete blended output of headlamp system 20.

In this embodiment of the present invention, lens 32 of the spread illumination pattern former has a modest and uniform vertical and horizontal spreading which is employed to blend the light emitted from light source array 24. For example, lens 32 can be a converging lens with a focal length of about 31 mm and can have a horizontal spread of about ±5.0 degrees and a vertical spread of about ±0.6 degrees. Light source array 24 can be an array of fiber optic cables, one end of each of which is optically coupled to an appropriate LED light source, not shown, or array 24 can be a combination of fiber optic cables, as described above, in combination with LED light sources mounted within array 24. In either case, because the spread of lens 32 is constant and relatively small, compared to the desired beam pattern formed by the spread illumination beam pattern former, lens 32 acts primarily as an imaging system providing a substantially one to one correspondence between an individual light source and a location in the resulting beam pattern. Preferably, the optical coupling of the LED light sources to the fiber optic cables includes a microreflector located on the substrate on which the LED is mounted, the microreflector surrounding the LED to reflect a substantial portion of the light produced by the LED into the fiber optic cable.

By using fiber optic cables to transfer the illumination provided by the LED sources to lens 32, spacing of the LEDs can be different from the spacing and arrangement of the light sources within array 24, allowing the LEDs to be arranged for simplified assembly, enhanced cooling, etc.

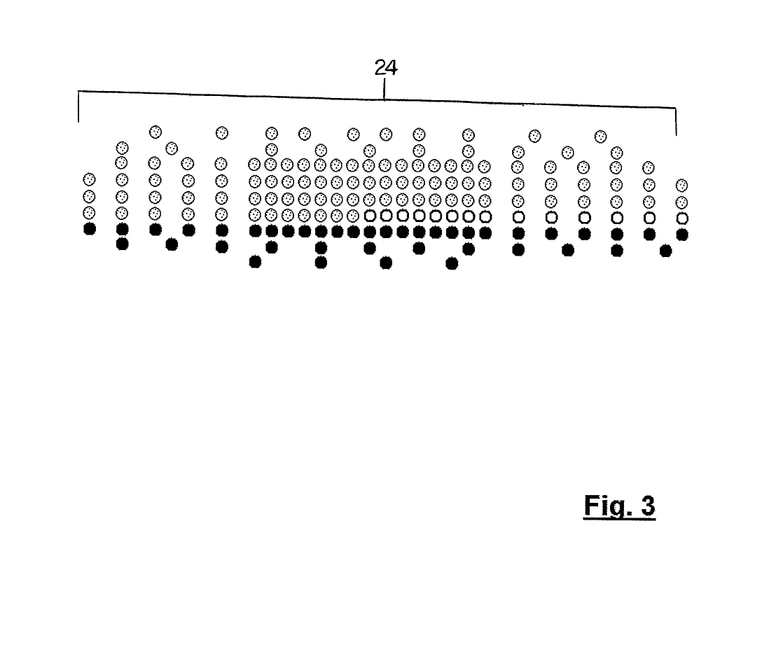

FIG. 3 shows one possible arrangement of light sources for light source array 24. In the Figure, the filled black circles represent light sources which are illuminated when headlamp 20 is projecting a high beam pattern of illumination and the stippled circles represent light sources which are illuminated when headlamp 20 is projecting a low beam pattern of illumination. The hollow circles in the pattern represent light sources which can optionally be included if headlamp steering is provided in the automobile in which headlamp 20 is employed.

Headlight steering systems are well known and provide illumination in the direction in which the wheels are turned when the automobile is being steered through a curve. This steered illumination can be achieved by mechanically moving components within the headlamp or by providing one or more additional illumination sources which are illuminated as the steering wheel is turned during driving. In headlamp 20, the sources represented by the hollow circles are sequentially illuminated to provide additional illumination in the desired direction as the steering wheel of the automobile is turned in the relevant direction.

As will be apparent to those of skill in the art, lens 32 inverts the pattern shown in FIG. 3, thus the high beam illumination sources are on the bottom of array 24 and the low beam illumination sources are shown on the top of array 24. Similarly, the optional headlamp steering sources are shown on the right hand side of array 24 but will provide illumination to the opposite side of headlamp 20. As illustrated, array 24 includes one hundred and sixty-four light sources.

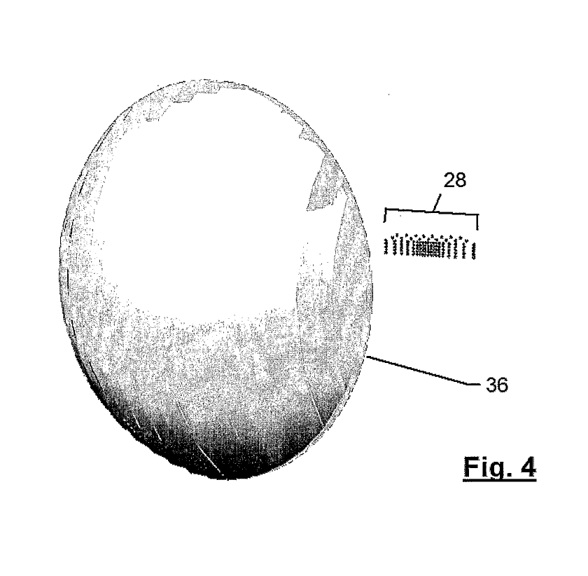

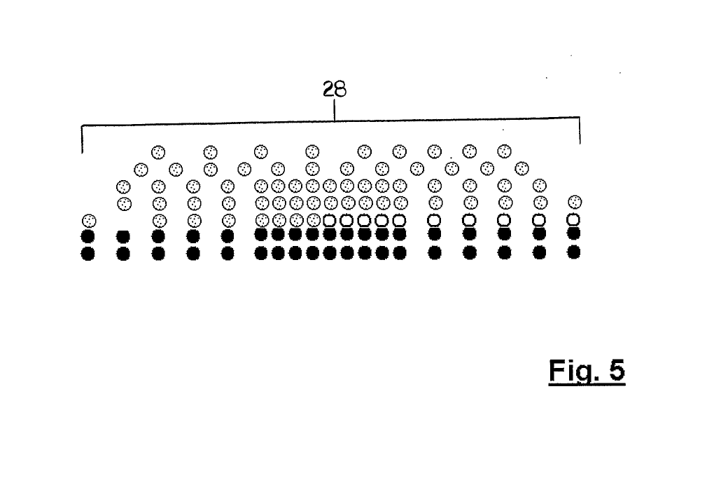

FIG. 4 shows the hot spot illumination pattern former comprising light source array 28 and lens 36 and FIG. 5 shows one possible arrangement for the light sources of array 28. In this example, lens 36 can be a converging lens with a focal length of about 69 mm and a horizontal spread of about ±2.5 degrees and a vertical spread of about ±0.25 degrees.

Again, light source array 28 can be an array of fiber optic cables, one end of each of which is optically connected to an appropriate LED light source, not shown, or array 28 can be a combination of fiber optic cables, as described above, in combination with LED light sources mounted within array 28. Again, in either case, because the spread of lens 36 is constant and relatively small, compared to the desired beam pattern formed by the spread illumination pattern former, lens 36 acts primarily as an imaging system providing a substantially one to one correspondence between an individual light source and a location in the resulting beam pattern.

Array 28, as shown in FIG. 5, includes a plurality of illumination sources, indicated by the black circles in the Figure, which are used to provide additional illumination to desired areas of higher illumination intensity, i.e.—hot spots, in the high beam pattern produced by headlamp 20. Similarly, array 28 also includes a plurality of illumination sources, indicated by the stippled circles in the Figure, which are used to provide additional illumination to desired areas of higher illumination intensity, i.e.—hot spots, in the low beam pattern produced by headlamp 20. Further, array 28 can optionally include additional light sources, indicated by the hollow circles in the Figure, for a headlight steering feature wherein these illumination sources are sequentially illuminated to provide additional illumination in the desired direction as the steering wheel of the automobile is turned in the relevant direction.

As discussed above for lens 32, lens 36 inverts the pattern shown in FIG. 5, thus the high beam illumination sources are on the bottom of array 28 and the low beam illumination sources are shown on the top of array 28. Similarly, the optional headlamp steering sources are shown on the right hand side of array 28 but will provide illumination to the opposite side of headlamp 20. As illustrated, array 28 includes one hundred and twelve light sources.

While two illumination beam pattern formers are illustrated for headlamp 20, the present invention is not so limited and additional illumination beam pattern formers with lenses of different focal lengths and/or spread patterns can be employed, with additional light source arrays, if it is desired to obtain different resulting beam patterns. Conversely, a single illumination beam pattern former can be employed in some circumstances, particularly if the size of headlamp 20 is a critical factor as only a single lens must be accommodated, although the resulting beam pattern formed may not be as desirable as one formed by a two illumination beam pattern former embodiment of headlamp 20 and more LED illumination sources maybe required in a single illumination array embodiment, than would be required in an embodiment with two or more illumination source arrays.

Illumination source arrays 24 and 28 need not only be activated for high beam, low beam and steering beam patterns. Additional lighting requirements, such as daytime running lights, fog lamps, etc, can also be provided by headlamp 20 by illuminating appropriate patterns of light sources within light source arrays 24 and 28.

The above-described embodiments of the invention are intended to be examples of the present invention and alterations and modifications may be effected thereto, by those of skill in the art, without departing from the scope of the invention which is defined solely by the claims appended hereto.

We claim:

1. A headlamp projecting at least one illumination beam pattern, comprising:
a first array of illumination light sources, the light sources arranged within the first array in a pattern which substantially corresponds to the pattern of illumination which is desired to be produced by the headlamp; and
a first converging lens having a substantially uniform spread, the uniform spread being larger in the horizontal direction than the vertical, the first lens receiving light produced by the first array of illumination sources and projecting the received light to form the at least one illumination beam pattern.

2. The headlamp of claim 1 wherein the first array of illumination light sources comprises a plurality of fiber optic cables, one end of each respective fiber optic cable being optically coupled to a respective one of a plurality of LED light sources, the other end of each respective fiber optic cable being substantially arranged corresponding to the illumination beam pattern, whereby the light emitted by the LED light sources is transferred by the fiber optic cables to the first lens in substantially the illumination beam pattern.

3. The headlamp of claim 2 further comprising a second array of illumination light sources and a second converging lens, the first array and first lens forming a spread portion of the at least one illumination beam pattern and the second array of illumination light sources and second lens forming at least one area of increased illumination superimposed onto the spread pattern formed by the first array and lens, the superimposition producing the at least one illumination beam pattern.

4. The headlamp of claim 3 wherein the first and second arrays of illumination light sources each comprise a plurality of fiber optic cables, one end of each respective fiber optic cable the respective arrays being optically coupled to a respective one of a plurality of LED light sources in the respective array, the other end of each respective fiber optic cable in each respective array being substantially arranged corresponding to a portion of the at least one illumination beam pattern, whereby the light emitted by the LED light sources in the first array is transferred by the fiber optic cables to the first lens and the light emitted by the LED sources in the second array is transferred by the fiber optic cables to the second lens and the light projected by the first and second lenses is superimposed to form the at least one illumination beam pattern.

5. The headlamp of claim 2 wherein the first array of illumination light sources further comprises a set of LED light sources which can be illuminated sequentially to provide a steerable light pattern superimposed upon the at least one illumination beam pattern.

6. The headlamp of claim 3 wherein the first and second arrays of illumination light sources farther comprise a set of LED light sources which can be illuminated sequentially to provide a steerable light pattern superimposed upon the at least one illumination pattern.

7. The headlamp of claim 2 wherein the optical coupling of the LED light sources to the each respective one end of the fiber optic cable includes a microreflector located on a substrate to which the LED is mounted, the microreflector surrounding the LED to reflect a substantial portion of the light produced by the LED into the fiber optic cable.

8. The headlamp of claim 2 wherein one wherein different ones of the light sources in light source array can be illuminated to form different illumination beam patterns.

9. The headlamp of claim 8 wherein the different illumination beam patterns include a low beam pattern and a high beam pattern.

10. The headlamp of claim 9 wherein the different illumination beam patterns further include a fog lamp pattern.

11. The headlamp of claim 9 wherein the different illumination beam patterns further include a day time running light pattern.

12. A headlamp employing a plurality of LED light sources as illumination sources, each respective LED light source being optically coupled to one end of a respective fiber optic cable, the other end of each fiber optic cable being arranged in an array having the general shape of a desired pattern of illumination to be output from the headlamp, the headlamp further including a lens to receive the light emitted from the ends of the fiber optic cables and to project that light into the desired illumination beam pattern.
